(19) United States
(12) Patent Application Publication
(10) Pub. No.: US 2014/0172733 A1
(43) Pub. Date: Jun. 19, 2014

(54) SCHOOL-FINDING TOOL

(71) Applicant: Linkedln Corporation, Mountain View, CA (US)

(72) Inventors: Christina Allen, Palo Alto, CA (US); Farid Hosseini, San Francisco, CA (US)

(73) Assignee: Linkedln Corporation, Mountain View, CA (US)

(21) Appl. No.: 14/083,086

(22) Filed: Nov. 18, 2013

Related U.S. Application Data
(60) Provisional application No. 61/737,699, filed on Dec. 14, 2012.

(51) Int. Cl. G06Q 50/20

(52) U.S. Cl. CPC G06Q 50/2053
USPC 705/327

(57) ABSTRACT

A technique for providing objective-related information is described. During this analysis technique, profiles of a group of individuals, who have achieved a desired objective of another individual (who is not in the group of individuals), are used to determine values of a set of attributes of these individuals. For example, information in the profiles may specify a social graph that include nodes corresponding to entities (such as the set of attributes) and edges corresponding to connections between the nodes (and, thus, between the entities). The relationships specified or embodied by the social graph may be used to determine the group of individuals and, thus, values of the set of attributes. Then, at least a subset of the values may be presented to the other individual. This information may be used by the other individual to increase the likelihood that they will achieve the objective.

### CROSS REFERENCE TO RELATED APPLICATION

This application claims priority under 35 U.S.C. §119(e) to U.S. Provisional Patent Application Ser. No. 61/737,699, entitled “School-Finding Tool” and filed on Dec. 14, 2012 (Attorney Docket LI-P0131.LNK.PROV), the contents of which are herein incorporated by reference.

### BACKGROUND

1. Field

The described embodiments relate to techniques for determining objective-related information. More specifically, the described embodiments relate to techniques for determining attributes of individuals that have achieved an objective of another individual.

2. Related Art

People regularly make decisions that affect their lives. For example, a student may select an educational institution, such as a college or a university. Typically, these decisions are based on characteristics or attributes of the educational institution, such as: its overall ranking, tuition, and/or the available fields of study.

While this approach to making a decision (in this example, selecting the educational institution) can be effective for many students, for other students it can be problematic. In particular, some students are less motivated by the attributes of the educational institution. Instead, these students may prefer to select the educational institution based on their goals or objectives. For example, a student may have a professional objective, such as a type of work they would like to do, a location where they would like to work, or a company where they would like to work.

In general, using the attributes of a particular educational institution, it can be difficult for students to determine how likely they are to achieve their objectives because, a priori, the relationship between the attributes and the objectives is often unknown. As a consequence, the students may make suboptimal or incorrect decisions, which may degrade their educational experience and decrease their satisfaction with the educational institution that they attend. In addition, the incorrect decisions may result in significant opportunity costs for the students, including reducing their ability to achieve their objectives.

### SUMMARY

The disclosed embodiments relate to a computer system that provides objective-related information. During operation, the computer system receives information specifying an objective of a first individual. Then, the computer system determines values for a set of attributes for a group of individuals who have achieved the objective, where the set of attributes is stored in profiles that include one or more attributes, and the group of individuals includes one or more individuals but excludes the first individual. Next, the computer system presents at least a subset of the values to the first individual.

Note that the objective of the first individual may include: a location where the first individual would like to work; an organization for which the first individual would like to work; and/or a job that the first individual would like to obtain. Moreover, the set of attributes may include: educational institutions that the group of individuals attended; and/or fields that the group of individuals studied.

In some embodiments, the profiles specify a social graph associated with the group of individuals, where the social graph includes nodes corresponding to entities and edges corresponding to connections between the entities that correspond to the nodes.

Furthermore, a given value presented to the first individual may have an associated rank corresponding to a number of individuals in the group that have the given value.

Additionally, prior to presenting the subset of values, the computer system may select the subset of the values based on criteria specified by the first individual (such as how many values they would like to view at a given time).

In some embodiments, the set of attributes includes organizations that include (or included) the group of individuals. Moreover, prior to presenting the subset of values, the computer system may select the subset of the values based on employment changes at the organizations. Thus, the presented subset of the values may vary dynamically with the employment changes at the organizations.

Another embodiment provides a method that includes at least some of the operations performed by the computer system.

Another embodiment provides a computer-program product for use with the computer system. This computer-program product includes instructions for at least some of the operations performed by the computer system.

### BRIEF DESCRIPTION OF THE FIGURES

FIG. 1 is a flow chart illustrating a method for providing objective-related information in accordance with an embodiment of the present disclosure.

FIG. 2 is a flow chart illustrating the method of FIG. 1 in accordance with an embodiment of the present disclosure.

FIG. 3 is a drawing illustrating a user interface for presenting at least a subset of values for a set of attributes for a group of individuals who have achieved an objective in accordance with an embodiment of the present disclosure.

FIG. 4 is a drawing illustrating a social graph in accordance with an embodiment of the present disclosure.

FIG. 5 is a block diagram illustrating a system that performs the method of FIGS. 1 and 2 in accordance with an embodiment of the present disclosure.

FIG. 6 is a block diagram illustrating a computer system that performs the method of FIGS. 1 and 2 in accordance with an embodiment of the present disclosure.

FIG. 7 is a block diagram illustrating a data structure for use in the computer system of FIG. 6 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a computer system, a technique for providing objective-related information, and a computer-program product (e.g., software) for use with the computer system are described. During this analysis technique, profiles of a group of individuals who have achieved a desired objective of another individual (who is not in the group of individuals), are used to determine values of a set of attributes of these individuals. For example, information in the profiles may specify a social graph that include nodes corresponding to entities (such as the set of attributes) and edges corresponding to connections between the nodes (and, thus, between the entities). The relationships specified or embodied by the social graph may be used to determine the group of individuals and, thus, values of the set of attributes. Then, at least a subset of the values may be presented to the other individual.

By reversing the question or query from ‘how should the other individual try to achieve the objective’ to ‘how did the group of individuals achieve the objective,’ the analysis technique may be able to successfully ‘postdict’ the desired answer (i.e., at least the subset of the values). In this way, the analysis technique may assist the other individual (and, more generally, a user of the analysis technique) to make better decisions. This may allow the other individual to increase the likelihood that they achieve their objective. Therefore, the analysis technique may: increase the satisfaction of the other individual, reduce the opportunity costs associated with suboptimal or incorrect decisions, and/or increase the revenue and profitability of a provider of the analysis technique.

In the discussion that follows, the other individual, the user or a recipient of at least the subset of the values may include a person (for example, an existing customer, a new customer, a student, a prospective employee, a supplier, a service provider, a vendor, a contractor, etc.). More generally, the analysis technique may be used by an organization, a business and/or a government agency. Furthermore, a ‘business’ should be understood to include: for-profit corporations, non-profit corporations, groups of individuals, sole proprietorships, government agencies, partnerships, etc.

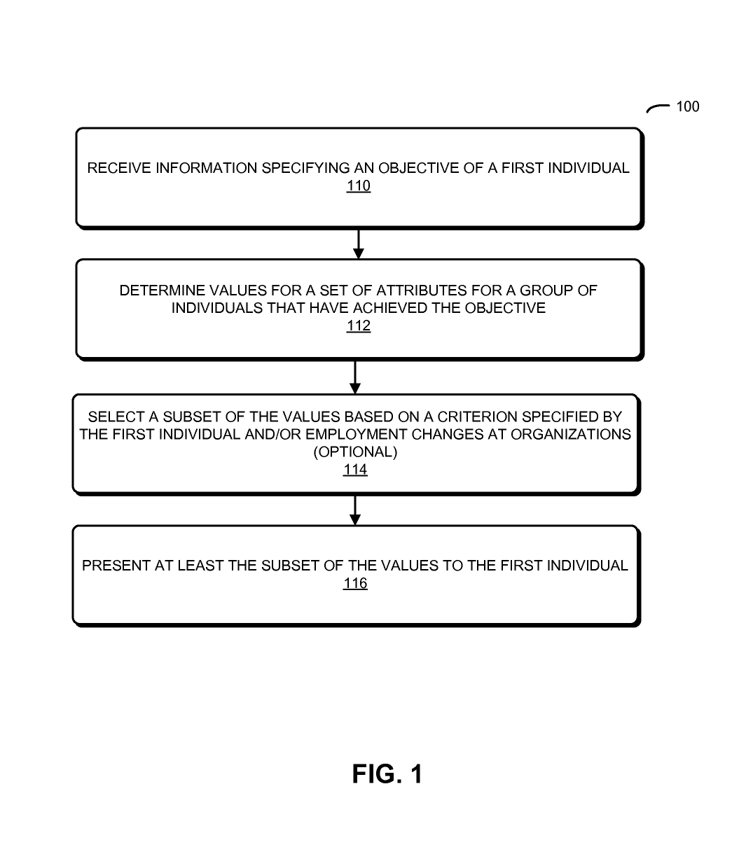

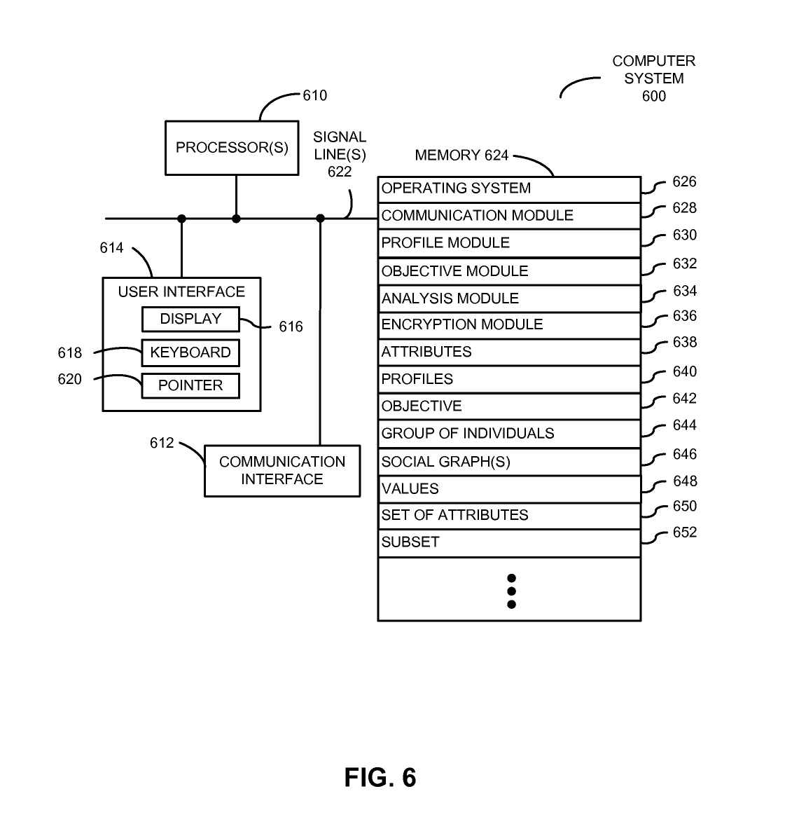

We now describe embodiments of the method. FIG. 1 presents a flow chart illustrating a method 100 for providing objective-related information, which may be performed by a computer system (such as computer system 600 in FIG. 6). During operation, the computer system receives information specifying an objective of a first individual (operation 110). For example, the objective may include: a location (such as a state) where the first individual would like to work; an organization (such as a company) for which the first individual would like to work; and/or a job (or job title) that the first individual would like to obtain.

Then, the computer system determines values for a set of attributes for a group of individuals who have achieved the objective (operation 112), where the set of attributes is stored in profiles that include one or more attributes, and the group of individuals includes one or more individuals but excludes the first individual. The set of attributes may include: educational institutions (such as colleges or universities) that the group of individuals attended, organizations (such as companies) that include (or included) the group of individuals, and/or fields that the group of individuals studied.

Next, the computer system presents at least a subset of the values to the first individual (operation 116). The presented subset of the values may facilitate decision-making by the first individual. For example, by using the information obtained from the group of individuals that have achieved the objective, the first individual may be able to select one or more educational institutions, organizations and/or fields of study that may increase the likelihood that they will be able to achieve the objective.

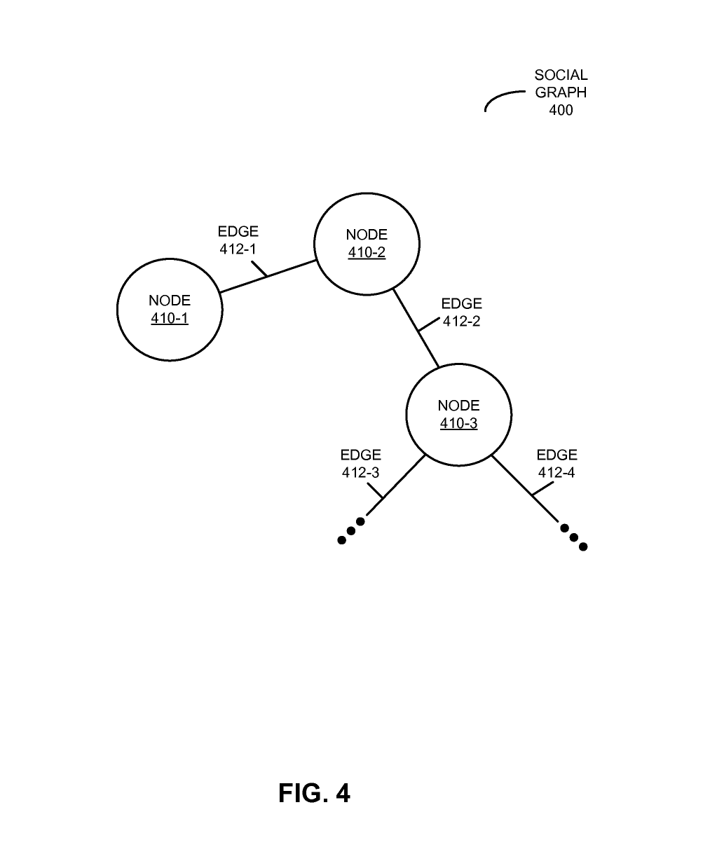

As described further below with reference to FIG. 4, in some embodiments the profiles specify a social graph associated with the group of individuals, where the social graph includes nodes corresponding to entities (such as the set of attributes) and edges corresponding to connections between the entities corresponding to the nodes. For example, an entity may include: a type of skill, a company where an individual worked, an organization that included the individual, a school that the individual attended, etc.

Furthermore, a given value presented to the first individual may have an associated rank corresponding to a number of individuals in the group that have the given value. This additional weighting may allow the first individual to focus on the values that are more likely to impact the ability of the first individual to achieve the objective. Alternatively or additionally, in some embodiments the computer system may generate a predictive model based on the subset of the values using a supervised learning technique, such as Support Vector Machines or Classification and Regression trees (and, more generally, a supervised learning technique known to one of skill in the art).

In some embodiments, prior to presenting the subset of values (operation 116), the computer system optionally selects the subset of the values based on criteria specified by the first individual and/or employment changes at the organizations (operation 114). The former may allow the first individual to tailor the presented subset of values to their needs. For example, the first individual may limit the number of values they would like to view at a given time to the top-N values (where N is an integer, such as 5 or 10).

Moreover, by selecting the subset of the values based on employment changes, the computer system may allow the first individual to focus on successful or up-and-coming organizations (such as those that are hiring), as opposed to those that may be in decline (as indicated by departures of key personnel, such as individuals in the group of individuals). Thus, the presented subset of the values may vary dynamically with the employment changes at the organizations.

In this way, the analysis technique may facilitate improved decision-making by the first individual by providing information that postdicts the actions needed to achieve the objective based on the prior actions (and successes) of the group of individuals.

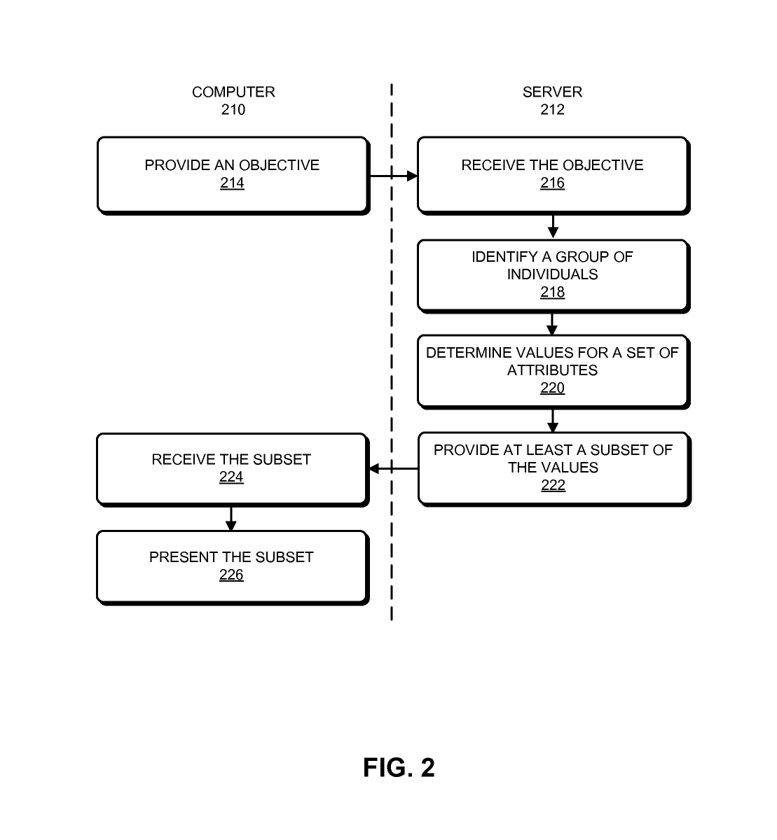

In an exemplary embodiment, the analysis technique is implemented using a computer and at least one server, which communicate through a network, such as a cellular-telephone network and/or the Internet (e.g., using a client-server architecture). This is illustrated in FIG. 2, which presents a flow chart illustrating method 100 (FIG. 1). During this method, a user of computer 210 (such as the first individual) may provide the objective (operation 214). This objective may be received (operation 216) by server 212.

In response to the received objective, server 212 may identify the group of individuals (operation 218) who have achieved the objective, and then may determine the values for the set of attributes (operation 220) of the group of individuals.

Next, server 212 provides at least the subset of the values (operation 222). After the subset of the values are received by computer 210 (operation 224), they may be presented to the user (operation 226). For example, computer 210 may display the subset of the values on a display.

In some embodiments of method 100 (FIGS. 1 and 2), there may be additional or fewer operations. Moreover, the order of the operations may be changed, and/or two or more operations may be combined into a single operation.

In an exemplary embodiment, the analysis technique is used to assist the first individual in identifying an educational institution where they would like to study. Moreover, the analysis technique may help the first individual determine what they would like to study.

In particular, instead of choosing one or more schools where they will apply based on the attributes of the schools or based on a field of study, a prospective student may instead specify their career objective (i.e., what they want to be). For example, the prospective student may indicate: where they want to work, the job they want to have and/or a company (or, more generally, an organization) that they want to work for or be associated with.

Using the career objective, a cohort or group of individuals that have already achieved the career objective may be identified based on values of attributes in the profiles of the group of individuals. For example, the prospective student may indicate that they want to be a Chief Technical Officer at a Fortune 100 company in the Northeastern United States. Based on this information, a cohort of individuals that are or have been Chief Technical Officers at Fortune 100 companies in the Northeastern United States may be identified.

Then, values for a set of attributes related to the objective for this cohort may be determined. For example, the set of attributes may include: the schools or secondary educational institutions that these individuals attended, their fields of study and/or organizations that included these individuals.

At least a subset of these values may be presented to the prospective student. In particular, the top-N (such as the top-5 or the top-10) most-common schools, fields of study and/or organizations for the group of individuals may be presented to the prospective student. Using these values, the prospective student may be able to select one or more schools to apply to, one or more fields of study to pursue and/or one or more organizations to apply to after they graduate. In this way, the prospective student may be more likely to achieve their career objective.

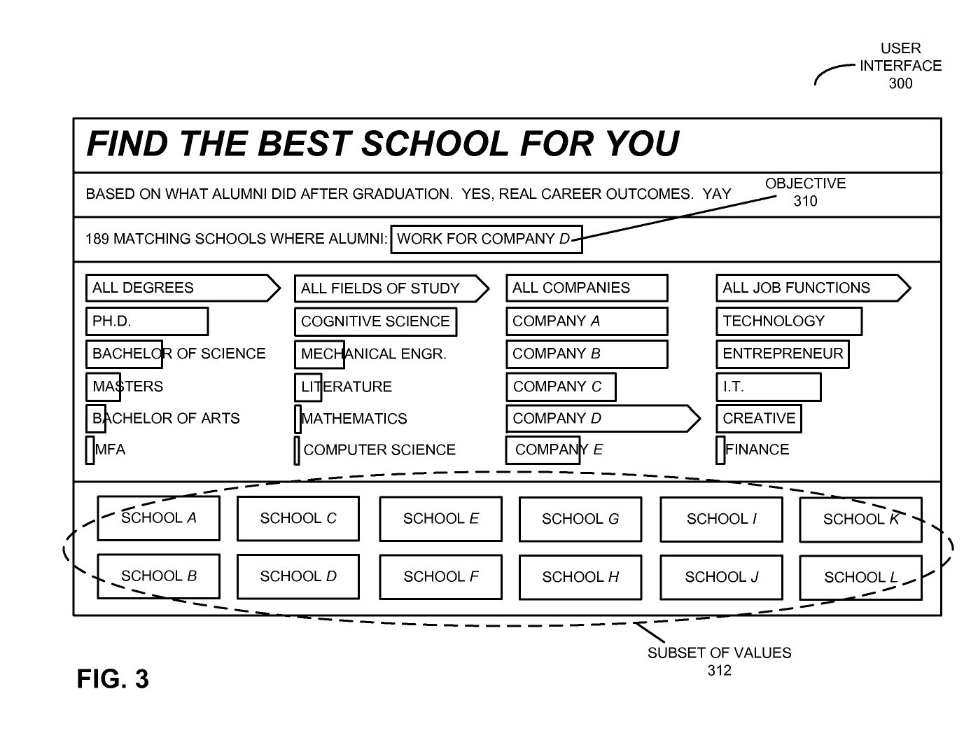

This analysis technique is further illustrated in FIG. 3, which presents a drawing illustrating a user interface 300 for presenting at least subset of values 312 for the set of attributes for the group of individuals who have achieved objective 310. In particular, as shown in FIG. 3, a user (such as the prospective student) may use user interface 300 to specify objective 310, such as to work for company D, as well as ‘all degrees,’ ‘all fields of study,’ and ‘all job functions.’ In response, the schools that current employees of company D attended (i.e. subset of values 312) are presented at the bottom of user interface 300. Moreover, as the user dynamically interacts with user interface 300, subset of values 312 may be updated.

We now further describe the profiles of the group of individuals. As noted previously, the profiles may specify a social graph. FIG. 4 presents a drawing illustrating a social graph 400. This social graph (which may correspond to the group of individuals) may represent the connections or inter-relationships among nodes 410 (corresponding to entities) using edges 412. In the context of the analysis technique, the objective may be one of nodes 410 (such as node 410-1), and values of the subset may be determined from the other nodes connected to node 410-1 by corresponding edges 412.

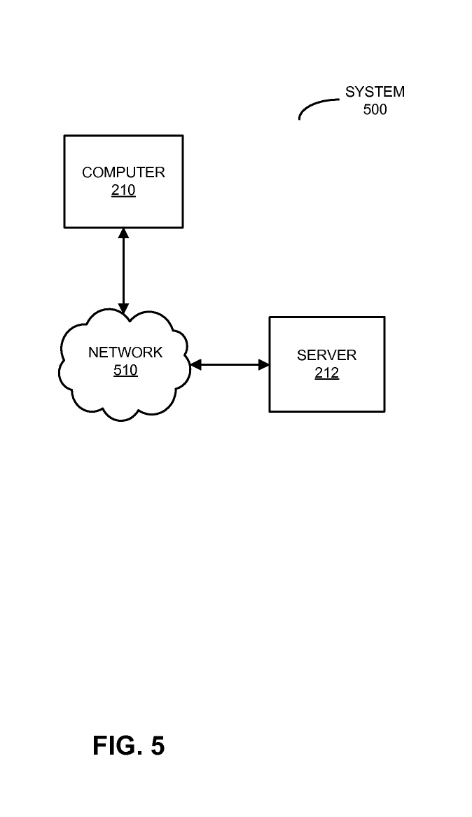

We now describe embodiments of the system and the computer system, and their use. FIG. 5 presents a block diagram illustrating a system 500 that performs method 100 (FIGS. 1 and 2). In this system, a user (such as the first individual) of computer 210 may use a software product, such as a software application that is resident on and that executes on computer 210.

Alternatively, the user may interact with a web page that is provided by server 212 via network 510, and which is rendered by a web browser on computer 210. For example, at least a portion of the software application may be an application tool that is embedded in the web page, and which executes in a virtual environment of the web browser. Thus, the application tool may be provided to the user via a client-server architecture.

The software application operated by the user may be a standalone application or a portion of another application that is resident on and which executes on computer 210 (such as a software application that is provided by server 212 or that is installed and which executes on computer 210).

As discussed previously, the user may use the software application to obtain the subset of values related to the objective of the user. In particular, the user may provide the objective to computer 210 (for example, by entering it using a user interface). This objective may be communicated to server 212 via network 510.

After receiving the objective, server 212 may use the information in the profiles to identify the group of individuals based on the objective.

Moreover, server 212 may determine the values for the set of attributes, and may provide at least the subset of the values to computer 210 via network 510. Computer 210 may present the subset of the values to the user after they are received, for example, by displaying the subset of the values on a display.

Note that information in system 500 may be stored at one or more locations in system 500 (i.e., locally or remotely). Moreover, because this data may be sensitive in nature, it may be encrypted. For example, stored data and/or data communicated via network 510 may be encrypted.

FIG. 6 presents a block diagram illustrating a computer system 600 that performs method 100 (FIGS. 1 and 2). Computer system 600 includes one or more processing units or processors 610, a communication interface 612, a user interface 614, and one or more signal lines 622 coupling these components together. Note that the one or more processors 610 may support parallel processing and/or multi-threaded operation, the communication interface 612 may have a persistent communication connection, and the one or more signal lines 622 may constitute a communication bus. Moreover, the user interface 614 may include: a display 616 (such as a touchscreen), a keyboard 618, and/or a pointer 620, such as a mouse.

Memory 624 in computer system 600 may include volatile memory and/or non-volatile memory. More specifically, memory 624 may include: ROM, RAM, EPROM, EEPROM, flash memory, one or more smart cards, one or more magnetic disc storage devices, and/or one or more optical storage devices. Memory 624 may store an operating system 626 that includes procedures (or a set of instructions) for handling various basic system services for performing hardware-dependent tasks. Memory 624 may also store procedures (or a set of instructions) in a communication module 628. These communication procedures may be used for communicating with one or more computers and/or servers, including computers and/or servers that are remotely located with respect to computer system 600.

Memory 624 may also include multiple program modules (or sets of instructions), including: profile module 630 (or a set of instructions), objective module 632 (or a set of instructions), analysis module 634 (or a set of instructions) and/or encryption module 636 (or a set of instructions). Note that one or more of these program modules (or sets of instructions) may constitute a computer-program mechanism.

During operation of computer system 600, profile module 630 may receive information from individuals (such as attributes 638, e.g., employment or educational history information) via communication interface 612 and communication module 628. In addition, profile module 630 may aggregate information about the individuals from external sources (such as websites) via communication module 628 and communication interface 612. Note that profile module 630 may include this information in profiles 640 that correspond to the individuals.

Subsequently, objective module 632 may receive an objective 642 from a user (such as the first individual or the prospective student) via communication interface 612 and communication module 628. After objective 642 is received, analysis module 634 may use the information in profiles 640 to identify group of individuals 644 based on objective 642. Furthermore, analysis module 634 may use attributes 638 in profiles 640 to generate one or more social graphs 646. These social graphs may be included in a data structure.

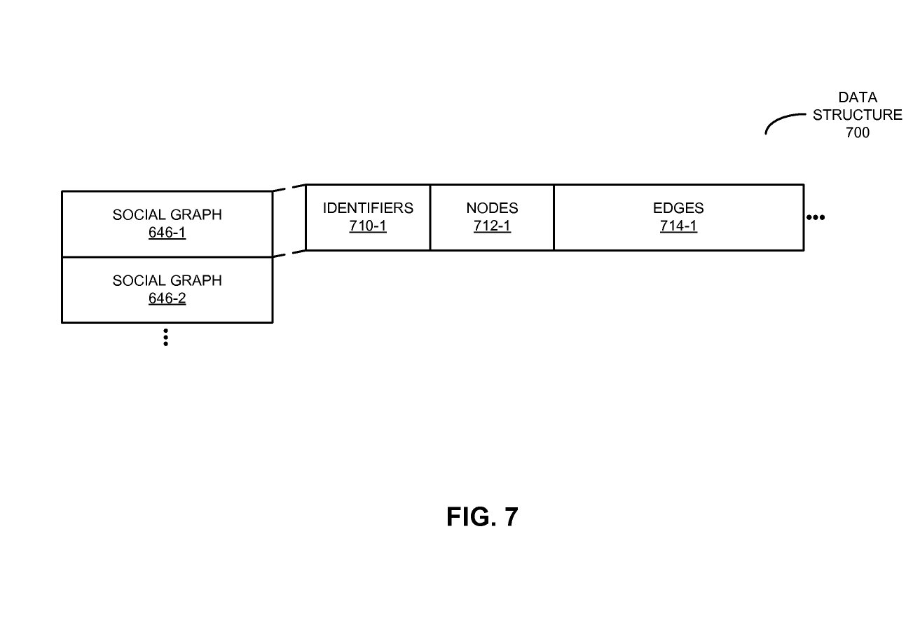

This is shown in FIG. 7, which presents a block diagram illustrating a data structure 700 with one or more social graphs 646 for use in computer system 600 (FIG. 6). In particular, social graph 646-1 may include: identifiers 710-1 for the individuals in group of individuals 644 (FIG. 6), nodes 712-1 (for associated attributes 638 in FIG. 6), and/or edges 714-1 that represent relationships or connections between nodes 712-1. For example, nodes 712-1 may include: skills, jobs, companies, schools, locations, etc. Thus, one of nodes 712-1 may be objective 642 (FIG. 6), and a remainder of nodes 712-1 may represent attributes 638 (FIG. 6) that are related to objective 642 (FIG. 6), as indicated by edges 714-1.

Referring back to FIG. 6, analysis module 634 may use the one or more social graphs 646 to determine values 648 of set of attributes 650 (such as the schools attended by group of individuals 644 that achieved objective 642), and objective module 632 may provide at least subset 652 to the user. For example, objective module 632 may present subset 652 on display 616. Alternatively, objective module 632 may provide subset 652 to the user via communication module 628 and communication interface 612.

While the preceding discussion illustrates the identification of subset 652 in response to the user specifying objective 642 (i.e., in real time or near-real time), in other embodiments the analysis technique may pre-identify multiple subsets for different objectives, so that subset 652 is already available when the user specifies objective 642. This ‘pre-calculating’ of subset 652 may be performed offline, and may significantly decrease the response time (i.e., the time needed to present subset 652), thereby improving the satisfaction of the user.

Because information in computer system 600 may be sensitive in nature, in some embodiments at least some of the data stored in memory 624 and/or at least some of the data communicated using communication module 628 is encrypted using encryption module 636.

Instructions in the various modules in memory 624 may be implemented in: a high-level procedural language, an object-oriented programming language, and/or in an assembly or machine language. Note that the programming language may be compiled or interpreted, e.g., configurable or configured, to be executed by the one or more processors.

Although computer system 600 is illustrated as having a number of discrete items, FIG. 6 is intended to be a functional description of the various features that may be present in computer system 600 rather than a structural schematic of the embodiments described herein. In practice, and as recognized by those of ordinary skill in the art, the functions of computer system 600 may be distributed over a large number of servers or computers, with various groups of the servers or computers performing particular subsets of the functions. In some embodiments, some or all of the functionality of computer system 600 is implemented in one or more application-specific integrated circuits (ASICs) and/or one or more digital signal processors (DSPs).

Computer systems (such as computer system 600), as well as computers and servers in system 500 (FIG. 5) may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 510 (FIG. 5) may include: the Internet, World Wide Web (WWW), an intranet, a cellular-telephone network, LAN, WAN, MAN, or a combination of networks, or other technology enabling communication between computing systems.

System 500 (FIG. 5), computer system 600 and/or data structure 700 (FIG. 7) may include fewer components or additional components. Moreover, two or more components may be combined into a single component, and/or a position of one or more components may be changed. In some embodiments, the functionality of system 500 (FIG. 5) and/or computer system 600 may be implemented more in hardware and less in software, or less in hardware and more in software, as is known in the art.

While the preceding embodiments illustrated the use of the analysis technique to obtain information (the subset of the values) based on a career objective, in other embodiments the analysis technique may use an arbitrary feature or attribute in the profiles of the individuals as a goal, which can be used to identify a corresponding cohort or group of individuals that have achieved this goal. Moreover, the relationships between the other attributes of this group of individuals and the goal can be used to assist a user of the analysis technique in decision-making.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-system-implemented method for providing objective-related information, the method comprising:
receiving information specifying an objective of a first individual;
using the computer system, determining values for a set of attributes for a group of individuals who have achieved the objective, wherein the set of attributes is stored in profiles and includes one or more attributes, and wherein the group of individuals includes one or more individuals but excludes the first individual; and
presenting at least a subset of the values to the first individual.

2. The method of claim 1, wherein the objective includes a location where the first individual would like to work.

3. The method of claim 1, wherein the objective includes an organization for which the first individual would like to work.

4. The method of claim 1, wherein the objective includes a job that the first individual would like to obtain.

5. The method of claim 1, wherein the set of attributes includes educational institutions that the group of individuals attended.

6. The method of claim 1, wherein the set of attributes includes fields that the group of individuals has studied.

7. The method of claim 1, wherein:
the profiles specify a social graph associated with the group of individuals; and
the social graph includes nodes corresponding to entities and edges corresponding to connections between the entities corresponding to the nodes.

8. The method of claim 1, wherein a given value presented to the first individual has an associated rank corresponding to a number of individuals in the group that have the given value.

9. The method of claim 1, wherein, prior to presenting the subset of values, the method further comprises selecting the subset of the values based on criteria specified by the first individual.

10. The method of claim 1, wherein:
the set of attributes includes organizations that include the group of individuals; and
prior to presenting the subset of values, the method further comprises selecting the subset of the values based on employment changes at the organizations.

11. A computer-program product for use in conjunction with a computer, the computer-program product comprising a non-transitory computer-readable storage medium and a computer-program mechanism embedded therein, to provide objective-related information, the computer-program mechanism including:
instructions for receiving information specifying an objective of a first individual;
instructions for determining values for a set of attributes for a group of individuals who have achieved the objective, wherein the set of attributes is stored in profiles and includes one or more attributes, and wherein the group of individuals includes one or more individuals but excludes the first individual; and
instructions for presenting at least a subset of the values to the first individual.

12. The computer-program product of claim 11, wherein the objective includes a location where the first individual would like to work.

13. The computer-program product of claim 11, wherein the objective includes an organization for which the first individual would like to work.

14. The computer-program product of claim 11, wherein the objective includes a job that the first individual would like to obtain.

15. The computer-program product of claim 11, wherein the set of attributes includes educational institutions that the group of individuals attended.

16. The computer-program product of claim 11, wherein the set of attributes includes fields that the group of individuals has studied.

17. The computer-program product of claim 11, wherein:
the profiles specify a social graph associated with the group of individuals; and
the social graph includes nodes corresponding to entities and edges corresponding to connections between the entities corresponding to the nodes.

18. The computer-program product of claim 11, wherein a given value presented to the first individual has an associated rank corresponding to a number of individuals in the group that have the given value.

19. The computer-program product of claim 11, wherein, prior to presenting the subset of values, the computer-program mechanism further comprises instructions for selecting the subset of the values based on criteria specified by the first individual.

20. A computer, comprising:
a processor;
memory; and
a program module, wherein the program module is stored in the memory and configurable to be executed by the processor to provide objective-related information, the program module including:
instructions for receiving information specifying an objective of a first individual;
instructions for determining values for a set of attributes for a group of individuals who have achieved the objective, wherein the set of attributes is stored in profiles and includes one or more attributes, and wherein the group of individuals includes one or more individuals but excludes the first individual; and
instructions for presenting at least a subset of the values to the first individual.
